(19) United States
(12) Patent Application Publication
(10) Pub. No.: US 2025/0173742 A1
(43) Pub. Date: May 29, 2025

(54) INFORMATION PROCESSING SYSTEM, INFORMATION PROCESSING METHOD, AND STORAGE MEDIUM

(71) Applicant: NEC Corporation, Minato-ku, Tokyo (JP)

(72) Inventors: Takashi NONAKA, Tokyo (JP); Kiri INAYOSHI, Tokyo (JP); Kentaro NISHIDA, Tokyo (JP)

(73) Assignee: NEC Corporation, Minato-ku, Tokyo (JP)

(21) Appl. No.: 18/843,823

(22) PCT Filed: Mar. 15, 2022
(86) PCT No.: PCT/JP2022/011476

§ 371 Date: Sep. 4, 2024

(51) Int. Cl. G06Q 30/0201; G06Q 30/0601

(52) U.S. Cl. CPC G06Q 30/0201; G06Q 30/0643

(57) ABSTRACT

In order to provide information suitable for effectively selling products at low cost and at a high speed, an information processing system (1) includes: a generation unit (11) that generates a virtual store space on the basis of design information related to a store; an acquisition unit (12) that acquires line-of-sight data and feeling data on a user who has entered the store space; and an analysis unit (13) that analyzes the design information on the basis of the line-of-sight data and the feeling data and outputs an analysis result.

### TECHNICAL FIELD

The present invention relates to an information processing system, an information processing method, and a program.

### BACKGROUND ART

There has been a demand for a technique for analyzing behaviors of customers in order to effectively sell products in a store in which the products are displayed.

Patent Literature 1 discloses a customer behavior analysis system that, in a state in which a customer grasps a product, detects whether or not the customer is viewing an identification indication of the product and generates customer behavior analysis information which includes a relationship between a result of the detection and a result on customer's purchase of the product.

### CITATION LIST

### Patent Literature

### Patent Literature 1

International Publication No. WO 2015/033577

### SUMMARY OF INVENTION

### Technical Problem

In the technique of Patent Literature 1, the behavior of the customer in a real store which is actually present is analyzed. This leads to a very high cost and further requires a long time.

An example aspect of the present invention has been made in view of the above problem, and an example of an object thereof is to provide a technique for providing information suitable for effectively selling products at low cost and at a high speed.

### Solution to Problem

An information processing system in accordance with an example aspect of the present invention includes: a generation means for generating a virtual store space on a basis of design information related to a store; an acquisition means for acquiring line-of-sight data and feeling data on a user who has entered the store space; and an analysis means for analyzing the design information on the basis of the line-of-sight data and the feeling data and outputting an analysis result.

An information processing method in accordance with an example aspect of the present invention includes: at least one processor generating a virtual store space on a basis of design information related to a store; the at least one processor acquiring line-of-sight data and feeling data on a user who has entered the store space; and the at least one processor analyzing the design information on the basis of the line-of-sight data and the feeling data and outputting an analysis result.

A program in accordance with an example aspect of the present invention causes a computer to function as: a generation means for generating a virtual store space on a basis of design information related to a store; an acquisition means for acquiring line-of-sight data and feeling data on a user who has entered the store space; and an analysis means for analyzing the design information on the basis of the line-of-sight data and the feeling data and outputting an analysis result.

### Advantageous Effects of Invention

According to an example aspect of the present invention, it is possible to provide a technique for effectively selling products at low cost.

### BRIEF DESCRIPTION OF DRAWINGS

FIG. 1 is a block diagram illustrating a configuration of an information processing system in accordance with a first example embodiment of the present invention.

FIG. 2 is a flowchart illustrating a flow of an information processing method in accordance with the first example embodiment of the present invention.

FIG. 3 is a block diagram illustrating a configuration of an analysis system in accordance with a second example embodiment of the present invention.

FIG. 4 is a sequence diagram illustrating a flow of an information processing method in accordance with the second example embodiment of the present invention.

FIG. 5 is a view illustrating an example of a store space displayed on a display in the second example embodiment of the present invention.

FIG. 6 is a view illustrating an example of an analysis result in the second example embodiment of the present invention.

FIG. 7 is a view illustrating another example of the analysis result in the second example embodiment of the present invention.

FIG. 8 is a view illustrating an example of an analysis result in a first variation of the present invention.

FIG. 9 is a sequence diagram illustrating a flow of an information processing method in accordance with a third example embodiment of the present invention.

FIG. 10 is a sequence diagram illustrating a flow of an information processing method in accordance with a second variation of the present invention.

FIG. 11 is a view illustrating an example of an experience space in the second variation of the present invention.

FIG. 12 is a block diagram illustrating an example of a hardware configuration of an image processing system, a virtual reality device, and a feeling analysis device in each of the example embodiments of the present invention.

### DESCRIPTION OF EMBODIMENTS

### First Example Embodiment

A first example embodiment of the present invention will be described in detail with reference to the drawings. The present example embodiment is a basic form of an example embodiment described later.

### Outline of Information Processing System 1

An information processing system 1 in accordance with the present example embodiment is a system that, on the basis of line-of-sight data and feeling data on a user who has entered a virtual store space based on design information related to a store (hereinafter, the “user” indicates a user who has entered a virtual store space, unless otherwise stated), analyzes the design information and outputs an analysis result.

The design information related to a store is information related to an object included in a store space, which is a space in a store, and information related to the store space. Examples of information included in the information related to an object included in a store space include a position of the object placed in the store space, movement of the object, a state of the object, and a price associated with the object. Examples of the information included in the information related to the store space include a structure of the store space, a size of the store space, and an environment of the store space. Here, the store may be a real store which can exist in a real space or may be a virtual store in which products are placed for sale in a virtual space.

The virtual store space refers to a space inside a store which is provided in a virtual space and in which products are arranged for sale. Examples of the store include a convenience store, a supermarket, and a vehicle sales store.

That is, by generating a virtual store space based on the design information related to a store, the information processing system 1 can provide, to the user, an experience that as if the user enters the store, views products in the store, walks in the store, and purchases a product in the store.

The line-of-sight data on the user can be acquired by using a known technique. Examples of the technique for acquiring the line-of-sight data on the user include a technique of identifying a feature point of the user, such as inner corners of eyes, outer corners of eyes, and pupils, from a video image captured of the user to acquire the line-of-sight data on the user.

Further, the feeling data on the user can also be acquired by using a known technique. Examples of the technique for acquiring the feeling data on the user include a technique of analyzing a physiological index of the user, a facial expression thereof, and a voice thereof and visualizing a feeling such as “excitement”, “stress”, and “relaxation” to acquire the feeling data on the user. Examples of the physiological index of the user include pulse waves, brain waves, a heart rate, and perspiration.

The analysis result output by the information processing system 1 includes a result obtained by analyzing the design information on the basis of the line-of-sight data and the feeling data. Examples of the analysis result output by the information processing system 1 include an object about which the user has shown a positive feeling (e.g., a feeling of being interested, a feeling of joy, etc.) or a negative feeling (e.g. a feeling of not being interested, a feeling of anxiety, etc.), a position of the object, and a place of the object in the store space. A process of generating an analysis result will be described later.

### Configuration of Information Processing System 1

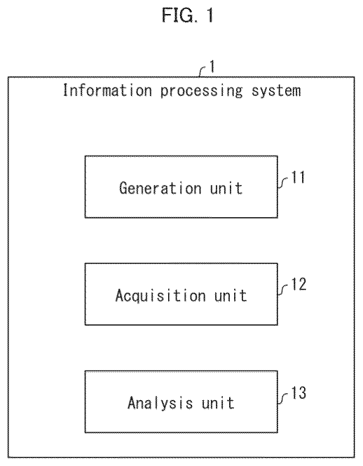

A configuration of an information processing system 1 in accordance with the present example embodiment will be described with reference to FIG. 1. FIG. 1 is a block diagram illustrating the configuration of the information processing system 1 in accordance with the present example embodiment.

As illustrated in FIG. 1, the information processing system 1 includes a generation unit 11, an acquisition unit 12, and an analysis unit 13. The generation unit 11, the acquisition unit 12, and the analysis unit 13 are configured to implement a generation means, an acquisition means, and an analysis means, respectively, in the present example embodiment.

The generation unit 11 generates a virtual store space on the basis of design information related to a store. The generation unit 11 supplies the generated virtual store space to the acquisition unit 12. As described above, the generation unit 11 may generate, on the basis of design information related to a real store which can exist in a real space, a store space that imitates the real store, or may generate the store space on the basis of design information related to a virtual store in which products are placed for sale in a virtual space.

The acquisition unit 12 acquires line-of-sight data and feeling data on a user who has entered the store space which has been acquired from the generation unit 11. The acquisition unit 12 supplies the acquired line-of-sight data and feeling data to the analysis unit 13.

The analysis unit 13 analyzes the design information on the basis of the line-of-sight data and the feeling data which have been acquired from the acquisition unit 12 and outputs an analysis result.

As an example, the analysis unit 13 identifies an object to which a line of sight of the user has been directed on the basis of the line-of-sight data. Further, the analysis unit 13 identifies the feeling of the user during a period in which the line of sight of the user has been directed to the identified object on the basis of the feeling data.

For example, in a case where the feeling data indicates a positive feeling during the period in which the line of sight of the user has been directed to the identified object, the analysis unit 13 outputs an analysis result concluding that the identified object is an object in which the user has gotten interested.

As another example, in a case where the feeling data indicates a negative feeling during the period in which the line of sight of the user has been directed to the identified object, or in a case where the feeling data indicates that there is no particular change in the feeling of the user during such a period, the analysis unit 13 outputs an analysis result concluding that the identified object is an object in which the user has not gotten interested.

As still another example, the analysis unit 13 identifies an object to which the line of sight of the user has not been directed on the basis of the line-of-sight data on the user. Then, the analysis unit 13 outputs an analysis result concluding that the object is an object in which the user has not gotten interested.

As described above, the information processing system 1 in accordance with the present example embodiment employs the configuration of including: the generation unit 11 that generates a virtual store space on the basis of design information related to a store; an acquisition unit 12 that acquires line-of-sight data and feeling data on a user who has entered the store space; and an analysis unit 13 that analyzes the design information on the basis of the line-of-sight data and the feeling data and outputs an analysis result.

Thus, according to the information processing system 1 in accordance with the present example embodiment, it is possible to analyze the behavior of the user in the virtual store space based on the design information related to a store, not in a real store which actually exists. Therefore, the information processing system 1 in accordance with the present example embodiment brings about the effect of providing information for effectively selling products at low cost and at a high speed.

In addition, the information processing system 1 in accordance with the present example embodiment analyzes the design information on the basis of the line-of-sight data on the user and further on the basis of the feeling data on the user, and thus brings about the effect of providing information suitable for effectively selling products.

### Flow of Information Processing Method S1

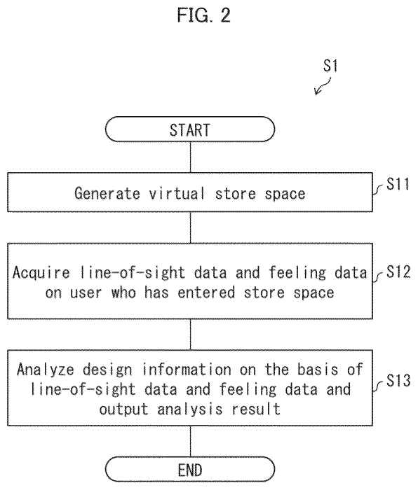

A flow of an information processing method S1 in accordance with the present example embodiment will be described with reference to FIG. 2. FIG. 2 is a flowchart illustrating the flow of the information processing method S1 in accordance with the present example embodiment.

### Step S11

In step S11, the generation unit 11 generates a virtual store space on the basis of design information related to a store. The generation unit 11 supplies the generated virtual store space to the acquisition unit 12.

### Step S12

In step S12, the acquisition unit 12 acquires line-of-sight data and feeling data on a user who has entered the store space which has been acquired from the generation unit 11. The acquisition unit 12 supplies the acquired line-of-sight data and feeling data to the analysis unit 13.

### Step S13

In step S13, the analysis unit 13 analyzes the design information on the basis of the line-of-sight data and the feeling data which have been acquired from the acquisition unit 12 and outputs an analysis result.

As described above, the information processing method S1 in accordance with the present example embodiment is such that: in step S11, the generation unit 11 generates a virtual store space on the basis of design information related to a store; in step S12, the acquisition unit 12 acquires line-of-sight data and feeling data on a user who has entered the store space which has been acquired from the generation unit 11; and in step S13, the analysis unit 13 analyzes the design information on the basis of the line-of-sight data and the feeling data which have been acquired from the acquisition unit 12 and outputs an analysis result. Thus, the information processing method S1 in accordance with the present example embodiment brings about the same effect as the above-described effect brought about by the information processing system 1.

### Second Example Embodiment

A second example embodiment of the present invention will be described in detail with reference to the drawings. The same reference numerals are given to constituent elements which have functions identical with those described in the first example embodiment, and descriptions as to such constituent elements are omitted as appropriate.

### Outline of Analysis System 100

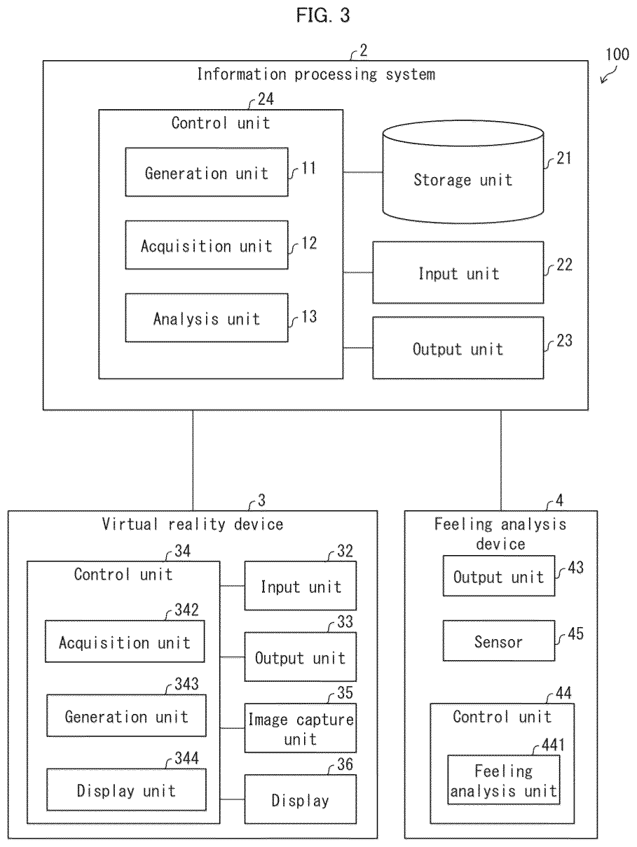

An analysis system 100 in accordance with the present example embodiment will be described with reference to FIG. 3. FIG. 3 is a block diagram illustrating a configuration of the analysis system 100 in accordance with the present example embodiment.

As illustrated in FIG. 3, the analysis system 100 is configured to include an information processing system 2, a virtual reality device 3, and a feeling analysis device 4. The information processing system 2, the virtual reality device 3, and the feeling analysis device 4 are communicably connected to each other.

Here, the information processing system 2, the virtual reality device 3, and the feeling analysis device 4 may be communicably connected to each other via a network which is not illustrated in FIG. 3. In this case, a specific configuration of the network is not intended to limit the present example embodiment. As an example of the network, a wireless local area network (LAN), a wired LAN, a wide area network (WAN), a public network, a mobile data communication network, or a combination of these networks can be used.

In the analysis system 100, the virtual reality device 3 provides, to a user, a virtual store space based on design information related to a store. Further, the virtual reality device 3 acquires line-of-sight data on the user during a period in which the virtual reality device 3 displays the store space thereon. Further, the feeling analysis device 4 generates feeling data obtained by analyzing the feeling of the user at least during the period in which the virtual reality device 3 displays the store space thereon. Then, the information processing system 2 analyzes the design information on the basis of the line-of-sight data and the feeling data and generates an analysis result. The information processing system 2 may output the generated analysis result to the virtual reality device 3 or may output the generated analysis result to another apparatus (not illustrated in FIG. 3).

The design information related to a store, the virtual store space, the line-of-sight data, the feeling data, and the analysis result are as described above.

### Outline of Virtual Reality Device 3

The virtual reality device 3 is a device that provides, to a user, a virtual store space. As an example, the virtual reality device 3 provides, to the user, the virtual store space by displaying the virtual store space thereon. As an example, the virtual reality device 3 provides, to the user, an experience of entrance to the virtual store space, an experience of movement in the store space, and an experience of shopping in the store space by detecting the direction of the line of sight of the user and the movement of the body of the user and changing a store space to be displayed in accordance with results of the detection.

Further, the virtual reality device 3 outputs line-of-sight data indicating the detected line of sight of the user. As a technique for acquiring the line-of-sight data on the user, a known technique can be used as described earlier. Here, the configuration for the detection of the line of sight of the user is not limited to a configuration in which the detection is made by the virtual reality device 3, and may be a configuration in which the detection is made by another apparatus.

Examples of the virtual reality device 3 include a wearable virtual reality device (e.g., a head-mounted display), a stationary virtual reality device, a display device (e.g., a liquid crystal monitor), a smartphone, and smart glasses.

### Configuration of Virtual Reality Device 3

As illustrated in FIG. 3, the virtual reality device 3 includes an input unit 32, an output unit 33, a control unit 34, an image capture unit 35, and a display 36.

The input unit 32 is an interface that acquires data from another apparatus connected thereto. The input unit 32 supplies the acquired data to the control unit 34. Examples of the data acquired by the input unit 32 include store space data indicating a store space.

The output unit 33 is an interface that outputs data to another apparatus connected thereto. The output unit 33 outputs the data supplied from the control unit 34. Examples of the data output by the output unit 33 include line-of-sight data.

The image capture unit 35 is a camera that is capable of capturing a moving image. The image capture unit 35 supplies the captured moving image to the control unit 34. Examples of the moving image captured by the image capture unit 35 include a moving image that includes a user's face (in particular, an area surrounding eyes) as a subject.

The display 36 is a device that displays an image thereon. The display 36 acquires the image data supplied from the control unit 34 and displays an image indicated by the image data. Examples of the image displayed on the display 36 include a virtual store space.

### Function of Control Unit 34

The control unit 34 controls constituent elements that are included in the virtual reality device 3. As illustrated in FIG. 3, the control unit 34 also functions as an acquisition unit 342, a generation unit 343, and a display unit 344.

The acquisition unit 342 acquires the data supplied to the control unit 34. Examples of the data acquired by the acquisition unit 342 include store space data supplied from the input unit 32 and the moving image supplied from the image capture unit 35. The acquisition unit 342 supplies the acquired store space data to the display unit 344 and supplies the acquired moving image to the generation unit 343.

The generation unit 343 analyzes the moving image and generates data. Examples of the moving image analyzed by the generation unit 343 include a moving image that includes a user as a subject, and examples of the data generated by the generation unit 343 include line-of-sight data. As described earlier, the generation unit 343 generates line-of-sight data by using a known technique. The generation unit 343 supplies the generated line-of-sight data to the output unit 33.

The display unit 344 acquires an image to be displayed and supplies image data indicating the image. Examples of the image data supplied by the display unit 344 include store space data that indicates a virtual store space and that is to be supplied to the display 36. Hereinafter, the configuration in which the display unit 344 supplies image data to the display 36, and the display 36 displays an image indicated by the image data is also expressed as a configuration in which the display unit 344 displays an image on the display 36.

### Outline of Feeling Analysis Device 4

The feeling analysis device 4 is a device that analyzes a feeling of a user. As a technique for the feeling analysis device 4 analyzing the feeling of the user, a known technique can be used as described earlier. The feeling analysis device 4 outputs the generated feeling data. Examples of the feeling analysis device 4 include a wristband-type wearable device.

### Configuration of Feeling Analysis Device 4

As illustrated in FIG. 3, the feeling analysis device 4 includes an output unit 43, a control unit 44, and a sensor 45.

The output unit 43 is an interface that outputs data to another apparatus connected thereto. The output unit 43 outputs the data supplied from the control unit 44. Examples of the data output by the output unit 43 include feeling data.

The sensor 45 is a sensor that detects at least one selected from the group consisting of a physiological index of a user, a facial expression thereof, and a voice thereof. The sensor 45 supplies, to the control unit 44, sensor data indicating at least one, detected by the sensor 45, selected from the group consisting of the physiological index of the user, the facial expression thereof, and the voice thereof.

The control unit 44 controls constituent elements that are included in the feeling analysis device 4. As illustrated in FIG. 3, the control unit 44 also functions as a feeling analysis unit 441.

The feeling analysis unit 441 analyzes the sensor data supplied from the sensor 45 (described later) and generates feeling data. The feeling analysis unit 441 supplies the generated feeling data to the output unit 43. As an example, the feeling analysis unit 441 analyzes at least one, supplied from the sensor 45, selected from the group consisting of the physiological index, the facial expression, and the voice to analyze the feeling of the user. Examples of the feeling data generated by the feeling analysis unit 441 include feeling data indicating that the feeling of the user is a positive feeling, and feeling data indicating that the feeling of the user is a negative feeling.

### Outline of Information Processing System 2

The information processing system 2 is a system that generates a virtual store space based on design information related to a store and outputs store space data indicating the store space. In addition, the information processing system 2 is a system that analyzes the design information on the basis of line-of-sight data and feeling data on a user and outputs an analysis result. Examples of the information processing system 2 include a server.

### Configuration of Information Processing System 2

As illustrated in FIG. 3, the information processing system 2 includes a storage unit 21, an input unit 22, an output unit 23, and a control unit 24.

The storage unit 21 stores various types of data referred to by the control unit 24 (described later). Examples of the data stored in the storage unit 21 include design information, store space data, line-of-sight data, feeling data, and an analysis result.

The input unit 22 is an interface that acquires data from another apparatus connected thereto. The input unit 22 supplies the acquired data to the control unit 24. Examples of the data acquired by the input unit 22 include line-of-sight data and feeling data.

The output unit 23 is an interface that outputs data to another apparatus connected thereto. The output unit 23 outputs the data supplied from the control unit 24. Examples of the data output by the output unit 23 include store space data and an analysis result.

### Function of Control Unit 24

The control unit 24 controls constituent elements that are included in the information processing system 2. As illustrated in FIG. 3, the control unit 24 also functions as a generation unit 11, an acquisition unit 12, and an analysis unit 13. The generation unit 11, the acquisition unit 12, and the analysis unit 13 are configured to implement a generation means, an acquisition means, and an analysis means, respectively, in the present example embodiment.

The generation unit 11 generates a virtual store space on the basis of design information related to a store. The generation unit 11 stores, in the storage unit 21, store space data indicating the generated store space. In addition, the generation unit 11 supplies, to the output unit 23, the store space data indicating the generated store space. As an example, the generation unit 11 acquires design information stored in the storage unit 21 and generates store space data indicating a store space based on the design information.

Further, the generation unit 11 may generate a store space on the basis of the design information and further on the basis of real-world constraint information related to a product to be sold in a store. Examples of the real-world constraint information related to the product to be sold in the store include information on the amount of stock of the product to be sold in the store. With this configuration, the generation unit 11 can generate a store space in which a space in a store is suitably used, since the generation unit 11 does not generate a store space having a wide space in which the product is placed, in spite of the fact that the product is out of stock.

The acquisition unit 12 acquires the data supplied from the input unit 22. The acquisition unit 12 stores the acquired data in the storage unit 21. Examples of the data acquired by the acquisition unit 12 include line-of-sight data and feeling data.

The analysis unit 13 analyzes the design information on the basis of the line-of-sight data and the feeling data and generates an analysis result. The analysis unit 13 supplies the generated analysis result to the output unit 23. As an example, the analysis unit 13 acquires line-of-sight data, feeling data, and design information stored in the storage unit 21, and analyzes the acquired design information on the basis of the acquired line-of-sight data and the feeling data.

Further, as in the case of the generation unit 11, the analysis unit 13 may analyze the design information, further on the basis of the real-world constraint information related to a product to be sold in a store. With this configuration, the analysis unit 13 also refers to whether a product is in stock or out of stock to analyze the design information, and thus the analysis unit 13 can output a suitable analysis result.

An example of the analysis result output by the analysis unit 13 will be described later.

### Flow of Information Processing Method S2

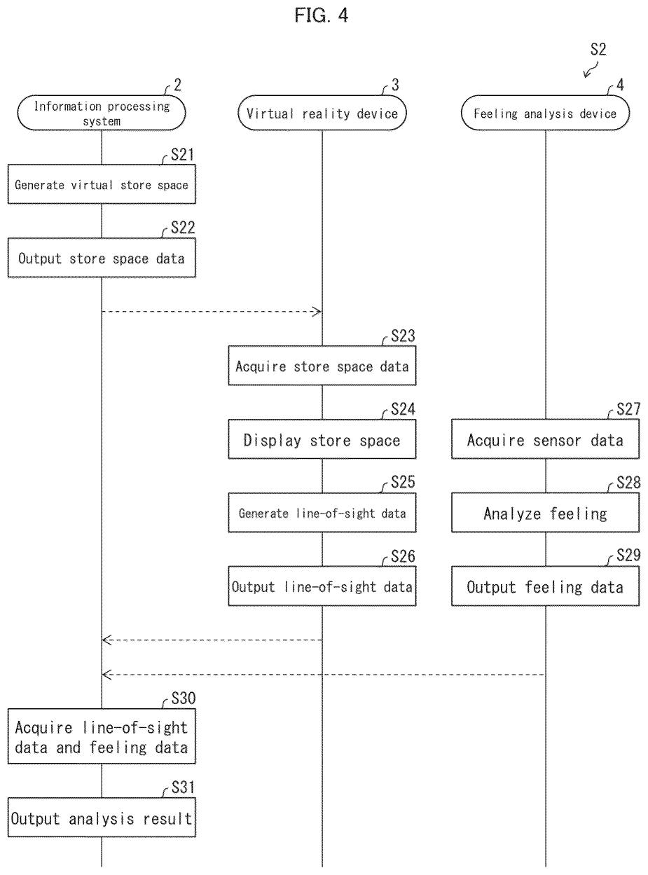

A flow of an information processing method S2 in accordance with the present example embodiment will be described with reference to FIG. 4. FIG. 4 is a sequence diagram illustrating the flow of the information processing method S2 in accordance with the present example embodiment.

### Step S21

In step S21, the generation unit 11 of the information processing system 2 generates a virtual store space on the basis of design information stored in the storage unit 21.

### Step S22

In step S22, the generation unit 11 outputs, to the virtual reality device 3 via the output unit 23, store space data indicating the generated store space. In addition, the generation unit 11 stores the store space data in the storage unit 21.

### Step S23

In step S23, the acquisition unit 342 of the virtual reality device 3 acquires the store space data output from the information processing system 2, via the input unit 32. The acquisition unit 342 supplies the acquired store space data to the display unit 344.

### Step S24

In step S24, the display unit 344 displays, on the display 36, the store space indicated by the store space data supplied from the acquisition unit 342. In other words, the generation unit 11 of the information processing system 2 displays the generated store space on the virtual reality device 3.

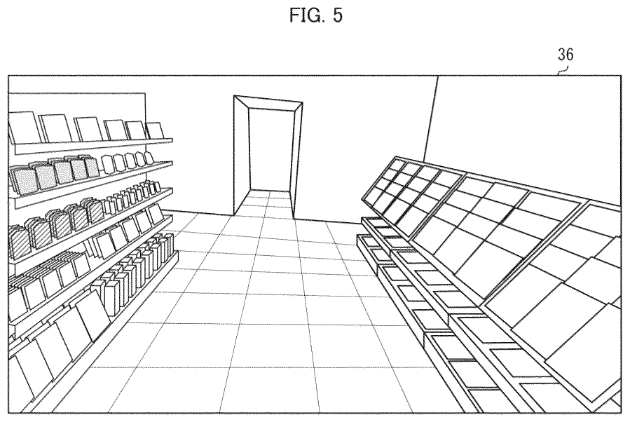

An example of the store space displayed on the display 36 in step S24 is illustrated in FIG. 5. FIG. 5 is a view illustrating an example of a store space displayed on the display 36 in the present example embodiment.

As illustrated in FIG. 5, the display unit 344 displays, on the display 36, a store space on the same level with the position of the user and the line of sight thereof. In the drawing illustrated in FIG. 5, in a case where, in an aisle between a shelf in which products are arranged and a bookshelf, the user is standing at a position such that the shelf in which the products are arranged is on the left side of the user, and the bookshelf is on the right side of the user, the state in the store that can be seen by the user is displayed on the display 36.

### Step S25

In step S25, the generation unit 343 generates line-of-sight data on the user. As an example, the generation unit 343 acquires a moving image that includes, as a subject, a user's face supplied by the image capture unit 35, and generates line-of-sight data on the basis of the moving image. A process of the generation unit 343 generating the line-of-sight data is as described above.

### Step S26

In step S26, the generation unit 343 outputs the generated line-of-sight data to the information processing system 2 via the output unit 33.

### Step S27

In step S27, the sensor 45 of the feeling analysis device 4 acquires sensor data at least during a period in which the virtual reality device 3 displays the store space. The sensor 45 supplies the acquired sensor data to the control unit 44.

Although how the acquisition of the sensor data by the sensor 45 is started (or finished) is not particularly limited, a configuration is included, as an example, in which, at a timing when the virtual reality device 3 starts (or finishes) the display of the store space, the sensor 45 acquires a signal indicating the timing from the virtual reality device 3. Upon acquiring the timing, the sensor 45 starts (or finishes) the acquisition of the sensor data.

### Step S28

In step S28, the feeling analysis unit 441 of the control unit 44 generates feeling data on the basis of the sensor data supplied from the sensor 45. A process of the feeling analysis unit 441 generating the feeling data is as described above.

### Step S29

In step S29, the feeling analysis unit 441 outputs the generated feeling data to the information processing system 2 via the output unit 43.

### Step S30

In step S30, the acquisition unit 12 of the information processing system 2 acquires the line-of-sight data output from the virtual reality device 3 and the feeling data output from the feeling analysis device 4, via the input unit 22.

### Step S31

In step S31, the acquisition unit 12 supplies the acquired line-of-sight data and feeling data to the analysis unit 13. The analysis unit 13 analyzes the design information on the basis of the supplied line-of-sight data and feeling data and outputs an analysis result. A process of the analysis unit 13 analyzing the design information on the basis of the line-of-sight data and the feeling data is as described above. In addition, the analysis unit 13 stores the analysis result in the storage unit 21.

The following will describe an example of the analysis result output by the analysis unit 13.

### Example of Analysis Result

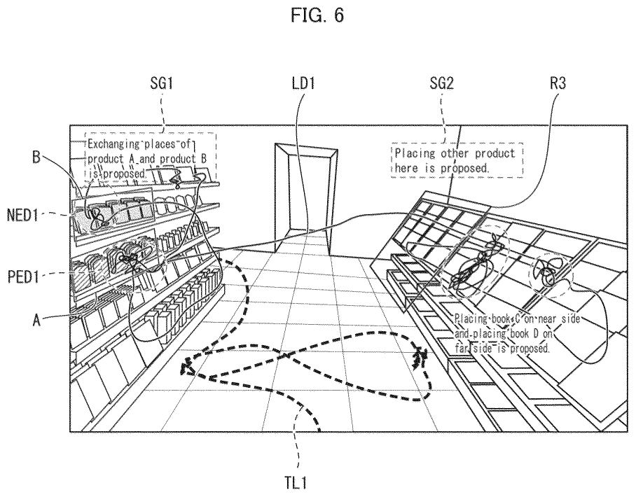

An example of the analysis result output by the analysis unit 13 will be described with reference to FIG. 6. FIG. 6 is a view illustrating an example of the analysis result in the present example embodiment.

As an example, the analysis unit 13 may include, in the analysis result, an image of a store space and output the analysis result. For example, as illustrated in FIG. 6, the analysis unit 13 outputs the analysis result that includes an image of a store space illustrated in FIG. 5. In this case, the analysis unit 13 refers to store space data that is stored in the storage unit 21.

Further, as illustrated in FIG. 6, the analysis unit 13 may include the acquired line-of-sight data LD1 in the analysis result. With this configuration, the analysis unit 13 can present which object is an object in which the user has shown an interest (or no interest).

Further, the analysis unit 13 may include, in the analysis result, the position of a line of sight of the user when the feeling of the user has become a positive feeling and the position of a line of sight of the user when the feeling of the user has become a negative feeling. As an example, as illustrated in FIG. 6, the analysis unit 13 may include, in the analysis result, feeling data PED1 indicating the position of the line of sight of the user when the feeling of the user has become a positive feeling and feeling data NED1 indicating the position of the line of sight of the user when the feeling of the user has become a negative feeling. With this configuration, the analysis unit 13 can present an object about which the user has had a positive feeling and an object about which the user has had a negative feeling among objects to which the user has directed the line of sight.

Further, the analysis unit 13 may also include, in the analysis result, a proposal for proposing to make a change to the design information. Examples of the proposal include the following:
To change shelving allocation in a store;
To change the area of a sales floor;
To change the layout of shelves;
To change the length and width of an aisle;
To pop up a predetermined product;
To change the color of a store space and the color of an object;
To display a package and contents of a product; and
To display a moving image related to a product (such as an advertisement moving image of a product and a moving image captured of how a product is produced).

As an example, as illustrated in FIG. 6, the analysis unit 13 may include, in the analysis result, a proposal SG1 for proposing to exchange the places of a product A about which the user has had a positive feeling and a product B about which the user has had a negative feeling.

Further, a configuration may be employed in which the acquisition unit 12 of the information processing system 2 further acquires traffic line data indicating a route through which the user has moved in the store space, and the analysis unit 13 analyzes the design information on the basis of the traffic line data as well. Examples of a method for acquiring the traffic line data include a configuration in which the traffic line data on the user is acquired from the virtual reality device 3.

In a case where the analysis unit 13 has acquired the traffic line data, the analysis unit 13 may include the acquired traffic line data TL1 in the analysis result, as illustrated in FIG. 6. With this configuration, the analysis unit 13 can present a place in which the user has shown an interest (or no interest) in the store space.

Further, the analysis unit 13 may also include, in the analysis result, a proposal for proposing to make a change to the design information on the basis of the traffic line data. As an example, as illustrated in FIG. 6, the analysis unit 13 may include, in the analysis result, a proposal SG2 for proposing to place other object at a place in which the user has shown no interest.

Thus, the information processing system 2 outputs the analysis result that includes a proposal based on the traffic line data, in addition to the line-of-sight data and the feeling data on the user, and thus brings about the effect of providing information suitable for effectively selling products.

### Another Example of Analysis Result

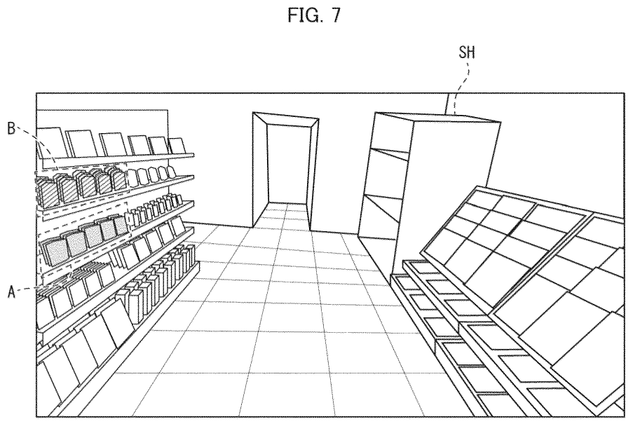

As another example, the analysis unit 13 may include, in the analysis result, post-change design information obtained by changing the design information and outputs the analysis result. For example, the analysis unit 13 may incorporate, into the analysis result, the above-described proposal and include post-change design information in the analysis result. In this case, a configuration may be employed in which the generation unit 11 changes the store space on the basis of the post-change design information, and the analysis unit 13 includes, in the analysis result, store space data indicating a changed store space. The analysis result including the post-change design information will be described with reference to FIG. 7. FIG. 7 is a view illustrating another example of the analysis result in the present example embodiment.

FIG. 7 is a view of a store space into which the proposal illustrated in FIG. 6 is incorporated and which is based on the post-change design information. In the analysis result illustrated in FIG. 7, the places of the product A and the product B are exchanged on the basis of the proposal SG1 illustrated in FIG. 6. In addition, in the analysis result illustrated in FIG. 7, a shelf SH is placed on the basis of the proposal SG2 illustrated in FIG. 6.

As described above, the information processing system 2 includes, in the analysis result, post-change design information obtained by changing the design information and outputs the analysis result, so that a changed store can be presented to the user.

### Variation of Analysis System 100

A variation (first variation) of the analysis system 100 will be described below.

In the analysis system 100 in accordance with the present variation, the information processing system 2 is configured to acquire line-of-sight data and feeling data with regard to a store space based on post-change design information and output the analysis result after the change.

A process in the present variation will be described with reference to FIG. 4 described above.

### Step S21

In step S21 described above, the generation unit 11 of the information processing system 2 generates a virtual store space on the basis of post-change design information stored in the storage unit 21.

Processes in steps S22 to S30 are as described above.

### Step S31

In step S31, the acquisition unit 12 supplies the acquired line-of-sight data and feeling data to the analysis unit 13. The analysis unit 13 analyzes the post-change design information on the basis of the supplied line-of-sight data and feeling data and outputs an analysis result.

### Example of Analysis Result in Present Variation

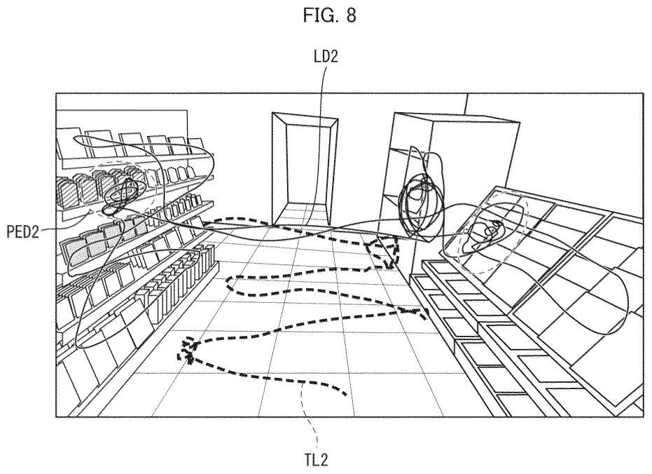

An example of an analysis result after a change of the store space will be described with reference to FIG. 8. FIG. 8 is a view illustrating an example of an analysis result in the present variation.

As an example, as illustrated in FIG. 8, the analysis unit 13 may include, in the analysis result, the store space data on a changed store space and acquired line-of-sight data LD2. With this configuration, the analysis unit 13 can present which object is an object in which the user has shown an interest (or no interest) in the changed store space.

Further, the analysis unit 13 may include, in the analysis result, the position of a line of sight of the user when the feeling of the user has become a positive feeling and the position of a line of sight of the user when the feeling of the user has become a negative feeling. As an example, as illustrated in FIG. 8, the analysis unit 13 may include, in the analysis result, feeling data PED2 indicating the position of the line of sight of the user when the feeling of the user has become a positive feeling. With this configuration, the analysis unit 13 can present an object about which the user has had a positive feeling and an object about which the user has had a negative feeling among objects to which the user has directed the line of sight in the changed store space.

Further, a configuration may be employed in which, in a case where the acquisition unit 12 of the information processing system 2 acquires traffic line data in the changed store space, the analysis unit 13 analyzes the design information on the basis of the traffic line data as well. In this case, as illustrated in FIG. 8, the analysis unit 13 may include the acquired traffic line data TL2 in the analysis result. With this configuration, the analysis unit 13 can present a place in which the user has shown an interest (or no interest) in the changed store space.

Further, the analysis unit 13 may include, in the analysis result, an analysis result obtained before the change of the store space and an analysis result obtained after the change of the store space and output the analysis result. As an example, the analysis unit 13 may include, in the analysis result, the image illustrated in FIG. 6 and the image illustrated in FIG. 8 and output the analysis result. With this configuration, the analysis unit 13 can present how the line-of-sight data and the feeling data have been changed by the change of the store space.

### Third Example Embodiment

A third example embodiment of the present invention will be described in detail with reference to the drawings. The same reference numerals are given to constituent elements which have functions identical with those described in the above-described example embodiments, and descriptions as to such constituent elements are not repeated.

### Outline of Analysis System 100A

An analysis system 100A in the present example embodiment provides, to a user, an experience of entrance to a store and an experience of shopping for a product in the store, while updating a store space in which the user has entered. As an example, in the analysis system 100A, the information processing system 2 changes the store space on the basis of line-of-sight data and feeling data, and the virtual reality device 3 displays the changed store space. Then, the information processing system 2 acquires line-of-sight data and feeling data with regard to the changed store space and changes the changed store space on the basis of the line-of-sight data and the feeling data, and the virtual reality device 3 displays the store space after the second change. In the analysis system 100A, these processes are repeatedly carried out.

Constituent elements of the information processing system 2, the virtual reality device 3, and the feeling analysis device 4 in the analysis system 100A are identical with the constituent elements in the second example embodiment described above. Therefore, descriptions as to such constituent elements are omitted here.

### Flow of Information Processing Method S3

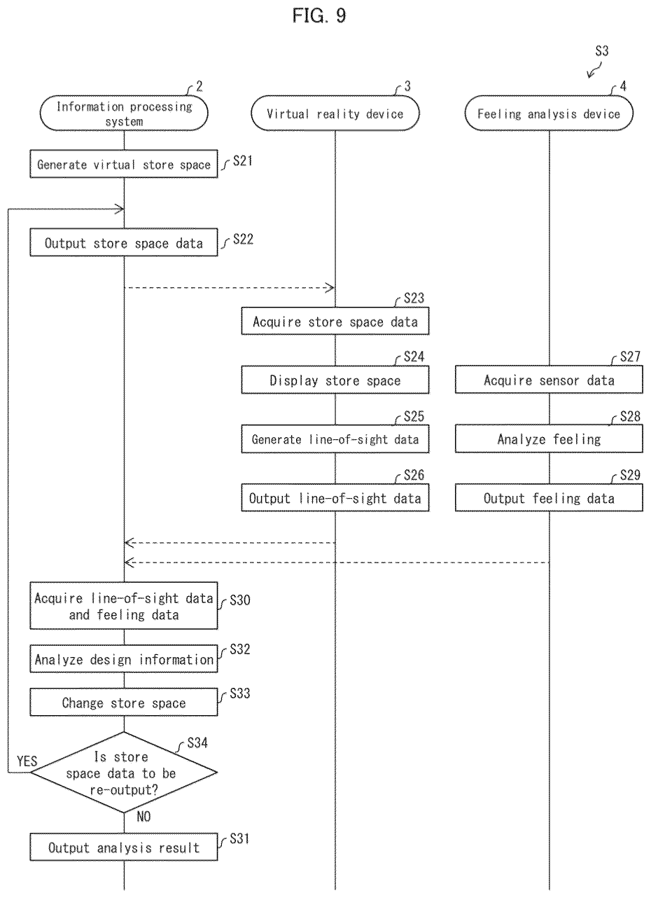

A flow of an information processing method S3 in accordance with the present example embodiment will be described with reference to FIG. 9. FIG. 9 is a sequence diagram illustrating the flow of the information processing method S3 in accordance with the present example embodiment.

### Steps S21 to S30

Processes in steps S21 to S30 are as described above.

### Step S32

In step S32, the acquisition unit 12 supplies, to the analysis unit 13, the line-of-sight data and the feeling data acquired in step S30. The analysis unit 13 analyzes the design information on the basis of the supplied line-of-sight data and feeling data. The analysis unit 13 changes the design information on the basis of the analysis result and stores the post-change design information in the storage unit 21.

Here, the process of the analysis unit 13 analyzing the design information on the basis of the line-of-sight data and the feeling data and the process of the analysis unit 13 changing the design information are as described above. A configuration may be employed in which, in addition to the above-described processes, a predetermined object specified on the basis of the line-of-sight data and the feeling data is included in the design information. As an example, the analysis unit 13 may change the design information such that an object included in the position of the line of sight of the user when the feeling of the user has become a positive feeling is included, as the predetermined object, in the store space in which the predetermined object is displayed, irrespective of the line of sight of the user. For example, in a case where the analysis unit 13 has analyzed that the user has a positive feeling about a product “umbrella” on the basis of the line-of-sight data and the feeling data, the analysis unit 13 includes, in the changed design information, information indicating the product “umbrella”.

### Step S33

In step S33, the generation unit 11 generates a changed virtual store space on the basis of the post-change design information stored in the storage unit 21.

Here, in a case where the information indicating the predetermined object is included in the post-change design information in step S33 described above, the generation unit 11 generates a virtual store space including the predetermined object. As an example, in a case where the information indicating the product “umbrella” is included, as the predetermined object, in the post-change design information, the generation unit 11 includes the product “umbrella” as the predetermined object in the changed virtual store space.

### Step S34

The generation unit 11 determines whether to re-output store space data indicating the changed virtual store space. Included as an example is a configuration in which the generation unit 11 re-outputs the store space data until a predetermined period (e.g., 5 minutes, 10 minutes, or the like) elapses after step S21 has been carried out. Included as another example is a configuration in which the generation unit 11 re-outputs the store space data for a predetermined number of times (e.g., five times, ten times, or the like).

In a case where, in step S34, it has been determined that the store space data is to be re-output (YES in step S34), the generation unit 11 returns to the process in step S22 and outputs the store space data to the virtual reality device 3 via the output unit 23. Then, the processes in step S23 and the following steps are carried out.

Here, in a case where the predetermined object is included in the changed virtual space store generated in step S33 described above, the display unit 344 of the virtual reality device 3 displays the store space including the predetermined object in step S24. As an example, in a case where the product “umbrella” is included, as the predetermined object, in the changed virtual store space, the display unit 344 displays the virtual store space including the product “umbrella”, irrespective of the line of sight of the user.

### Step S31

In a case where, in step S34, it has been determined that the store space data is not to be re-output (YES in step S34), the analysis unit 13 outputs the analysis result in step S31. The process of the analysis unit 13 outputting the analysis result is as described above.

In this way, in the analysis system 100A in the present example embodiment, the information processing system 2 analyzes design information on the basis of acquired line-of-sight data and feeling data and outputs, to the virtual reality device 3, store space data indicating a store space based on post-change design information. Further, the information processing system 2 acquires line-of-sight data and feeling data with regard to the store space based on the design information that has been changed, and repeats the output of the store space data indicating the store space based on the design information that has been changed again.

Thus, the analysis system 100A in the present example embodiment enables the user to experience, in real time, the store space based on the design information that has been changed and enables analysis of a behavior of the user in the store space based on the design information that has been changed. Therefore, the analysis system 100A brings about the effect of providing information for effectively selling products at low cost and at a high speed.

### Variation of Analysis System 100A

A variation (second variation) of the analysis system 100A will be described below.

The analysis system 100A in the present variation provides, to the user, a product-related virtual experience in a store space.

### Flow of Information Processing Method S4

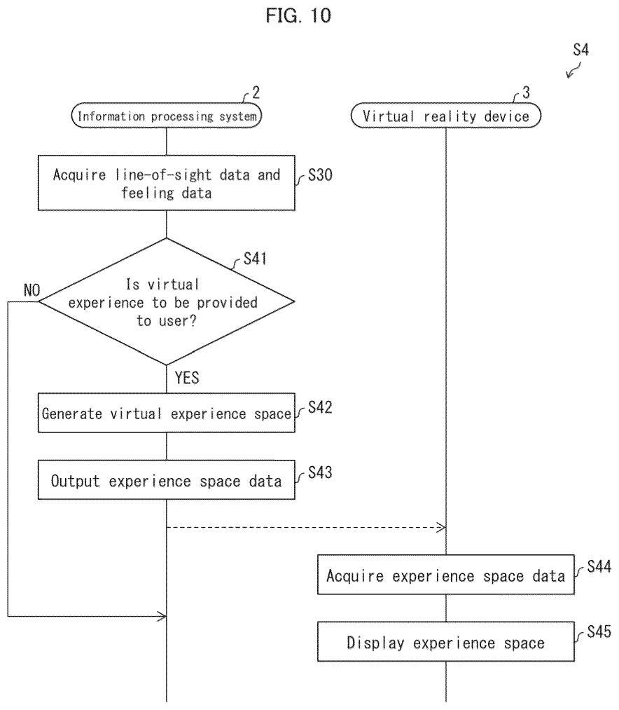

A flow of an information processing method S4 in the present variation will be described with reference to FIG. 10. FIG. 10 is a sequence diagram illustrating the flow of the information processing method S4 in accordance with the present variation. Although the process carried out by the feeling analysis device 4 is omitted in the sequence diagram illustrated in FIG. 10, the feeling analysis device 4 may acquire sensor data and output feeling data, as illustrated in FIGS. 4 and 9.

Further, since, in the sequence diagram illustrated in FIG. 10, the processes in steps S21 to S29 are identical to those illustrated in FIGS. 4 and 9, the descriptions thereof are omitted.

### Step S30

In step S30, the acquisition unit 12 of the information processing system 2 acquires the line-of-sight data output from the virtual reality device 3 and the feeling data output from the feeling analysis device 4, via the input unit 22.

### Step S41

In step S41, the acquisition unit 12 supplies the acquired line-of-sight data and feeling data to the analysis unit 13. The analysis unit 13 analyzes the design information on the basis of the supplied line-of-sight data and feeling data. Then, the analysis unit 13 determines, on the basis of the analysis result as well, whether to provide, to the user, a product-related virtual experience in the store space.

As an example, in a case where the analysis unit 13 has identified an object about which the user has had a positive feeling on the basis of the acquired line-of-sight data and feeling data, the analysis unit 13 determines that a virtual experience related to the object is to be provided to the user.

As another example, in a case where an operation for requesting a virtual experience related to the object in the store space has been acquired from the user (e.g., a case where information indicating that the user touched the object has been acquired and a case where voice data indicating that the user wants to use the object has been acquired), the analysis unit 13 determines that a product-related virtual experience in the store space is to be provided to the user.

In step S41, in a case where it has been determined that the product-related virtual experience in the store space is not to be provided to the user (NO in step S41), the process in the information processing method S4 ends.

### Step S42

In a case where, in step S41, it has been determined that the product-related virtual experience in the store space is to be provided to the user (YES in step S41), the generation unit 11 generates a virtual experience space for providing a virtual experience to the user in step S42.

### Step S43

In step S43, the generation unit 11 outputs, to the virtual reality device 3 via the output unit 23, experience space data indicating the generated experience space.

### Step S44

In step S44, the acquisition unit 342 of the virtual reality device 3 acquires the experience space data output from the information processing system 2, via the input unit 32. The acquisition unit 342 supplies the acquired experience space data to the display unit 344.

### Step S45

In step S45, the display unit 344 displays, on the display 36, the experience space indicated by the experience space data supplied from the acquisition unit 342.

### Example of Experience Space

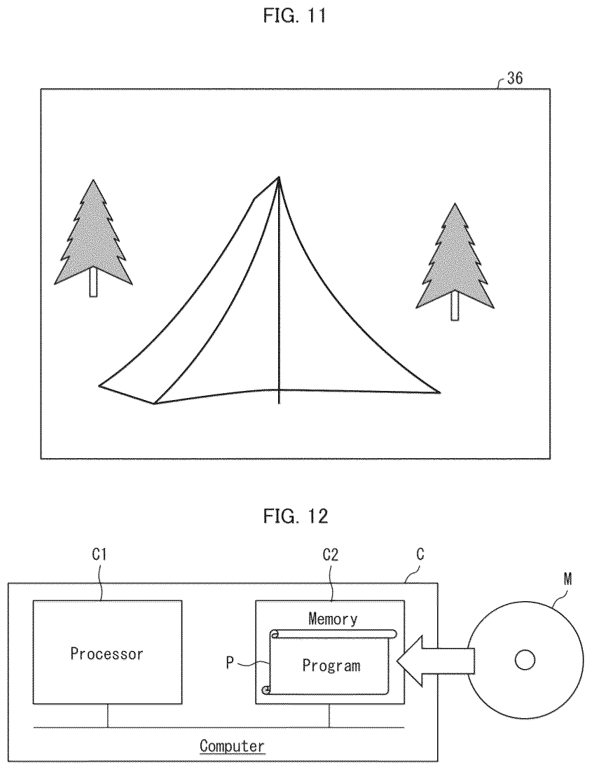

An example of the experience space displayed by the display unit 344 of the virtual reality device 3 will be described with reference to FIG. 11. FIG. 11 is a view illustrating an example of an experience space in the present variation.

As an example, in a case where the analysis unit 13 has determined that the user has had a positive feeling about a tent in the store space, the generation unit 11 generates an experience space that allows the user to experience the use of the tent.

When the generation unit 11 has generated the experience space, the display unit 344 of the virtual reality device 3 displays the experience space on the display 36. As an example, as illustrated in FIG. 11, the display unit 344 provides, as the experience space, a campsite in which the tent is set up.

As another example of the experience space that can be provided by the analysis system 100A in the present variation, it is possible to provide a space in which a vehicle is test-driven, a space in which furniture is used, a space in which the use of sports goods is experienced, and the like.

### Software Implementation Example

Some or all of functions of the information processing systems 1 and 2, the virtual reality device 3, and the feeling analysis device 4 can be realized by hardware such as an integrated circuit (IC chip) or can be alternatively realized by software.

In the latter case, the information processing systems 1 and 2, the virtual reality device 3, and the feeling analysis device 4 are each realized by, for example, a computer that executes instructions of a program that is software realizing the foregoing functions. FIG. 12 illustrates an example of such a computer (hereinafter, referred to as “computer C”). The computer C includes at least one processor C1 and at least one memory C2. The at least one memory C2 stores a program P for causing the computer C to operate as the information processing systems 1 and 2, the virtual reality device 3, and the feeling analysis device 4. In the computer C, the processor C1 reads the program P from the memory C2 and executes the program P, so that the functions of the information processing systems 1 and 2, the virtual reality device 3, and the feeling analysis device 4 are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. As the memory C2, for example, it is possible to use a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

Some of or all of the foregoing example embodiments can also be described as below. Note, however, that the present invention is not limited to the following example aspects.

### Supplementary Note 1

An information processing system including: a generation means for generating a virtual store space on a basis of design information related to a store; an acquisition means for acquiring line-of-sight data and feeling data on a user who has entered the store space; and an analysis means for analyzing the design information on the basis of the line-of-sight data and the feeling data and outputting an analysis result.

### Supplementary Note 2

The information processing system described in supplementary note 1, wherein the generation means generates, on the basis of the design information related to a real store which can exist in a real space, the store space that imitates the real store.

### Supplementary Note 3

The information processing system described in supplementary note 1, wherein the generation means generates the store space on the basis of the design information related to a virtual store in which products are placed for sale in a virtual space.

### Supplementary Note 4

The information processing system described in any one of supplementary notes 1 to 3, wherein: the analysis means determines, on the basis of the analysis result, whether to provide, to the user, a product-related virtual experience in the store space; and, in a case where it has been determined that the virtual experience is to be provided, the generation means generates a virtual experience space for providing, to the user, the virtual experience.

### Supplementary Note 5

The information processing system described in any one of supplementary notes 1 to 4, wherein the design information includes at least one selected from the group consisting of a position of an object placed in the store space, movement of the object, a state of the object, and a price associated with the object.

### Supplementary Note 6

The information processing system described in any one of supplementary notes 1 to 5, wherein the design information includes at least one selected from the group consisting of a structure of the store space, a size of the store space, and an environment of the store space.

### Supplementary Note 7

The information processing system described in any one of supplementary notes 1 to 6, wherein the analysis means includes, in the analysis result, post-change design information obtained by changing the design information and outputs the analysis result.

### Supplementary Note 8

The information processing system described in supplementary note 7, wherein the generation means changes the store space on the basis of the post-change design information.

### Supplementary Note 9

The information processing system described in supplementary note 8, wherein the analysis means includes, in the analysis result, an analysis result obtained before the change of the store space and an analysis result obtained after the change of the store space and outputs the analysis result.

### Supplementary Note 10

The information processing system described in any one of supplementary notes 1 to 9, wherein the acquisition means further acquires traffic line data on the user, and the analysis means analyzes the design information, further on the basis of the traffic line data.

### Supplementary Note 11

The information processing system described in any one of supplementary notes 1 to 10, wherein the generation means generates the store space on the basis of the design information and further on the basis of real-world constraint information related to a product to be sold in the store.

### Supplementary Note 12

The information processing system described in any one of supplementary notes 1 to 11, wherein the generation means displays the store space on a virtual reality device.

### Supplementary Note 13

An information processing method including: at least one processor generating a virtual store space on a basis of design information related to a store; the at least one processor acquiring line-of-sight data and feeling data on a user who has entered the store space; and the at least one processor analyzing the design information on the basis of the line-of-sight data and the feeling data and outputting an analysis result.

### Supplementary Note 14

A program for causing a computer to function as: a generation means for generating a virtual store space on a basis of design information related to a store; an acquisition means for acquiring line-of-sight data and feeling data on a user who has entered the store space; and an analysis means for analyzing the design information on the basis of the line-of-sight data and the feeling data and outputting an analysis result.

### Additional Remark 3

Furthermore, some of or all of the foregoing example embodiments can also be described as below.

An information processing system including at least one processor, the at least one processor being configured to carry out: a generation process of generating a virtual store space on a basis of design information related to a store; an acquisition process of acquiring line-of-sight data and feeling data on a user who has entered the store space; and an analysis of analyzing the design information on the basis of the line-of-sight data and the feeling data and outputting an analysis result.

Note that the information processing system can further include a memory. The memory can store a program for causing the processor to execute the generation process, the acquisition process, and the analysis process. The program can be stored in a computer-readable non-transitory tangible storage medium.

### REFERENCE SIGNS LIST

1, 2: information processing system
3: virtual reality device
4: feeling analysis device
11: generation unit
12: acquisition unit
13: analysis unit

What is claimed is:

1. An information processing system comprising:
at least one processor, the at least one processor carrying out:
a generation process of generating a virtual store space on a basis of design information related to a store;
an acquisition process of acquiring line-of-sight data and feeling data on a user who has entered the store space; and
an analysis process of analyzing the design information on the basis of the line-of-sight data and the feeling data and outputting an analysis result.

2. The information processing system according to claim 1, wherein
in the generation process, the at least one processor generates, on the basis of the design information related to a real store which can exist in a real space, the store space that imitates the real store.

3. The information processing system according to claim 1, wherein
in the generation process, the at least one processor generates the store space on the basis of the design information related to a virtual store in which products are placed for sale in a virtual space.

4. The information processing system according to claim 1, wherein:
in the analysis process, the at least one processor determines, on the basis of the analysis result, whether to provide, to the user, a product-related virtual experience in the store space; and
in a case where it has been determined that the virtual experience is to be provided, in the generation process, the at least one processor generates a virtual experience space for providing, to the user, the virtual experience.

5. The information processing system according to claim 1, wherein
the design information includes at least one selected from the group consisting of a position of an object placed in the store space, movement of the object, a state of the object, and a price associated with the object.

6. The information processing system according to claim 1, wherein
the design information includes at least one selected from the group consisting of a structure of the store space, a size of the store space, and an environment of the store space.

7. The information processing system according to claim 1, wherein
in the analysis process, the at least one processor includes, in the analysis result, post-change design information obtained by changing the design information and outputs the analysis result.

8. The information processing system according to claim 7, wherein
in the generation process, the at least one processor changes the store space on the basis of the post-change design information.

9. The information processing system according to claim 8, wherein
in the analysis process, the at least one processor includes, in the analysis result, an analysis result obtained before the change of the store space and an analysis result obtained after the change of the store space and outputs the analysis result.

10. The information processing system according to claim 1, wherein:
in the acquisition process, the at least one processor further acquires traffic line data on the user; and
in the analysis process, the at least one processor analyzes the design information, further on the basis of the traffic line data.

11. The information processing system according to claim 1, wherein in the generation process, the at least one processor generates the store space on the basis of the design information and further on the basis of real-world constraint information related to a product to be sold in the store.

12. The information processing system according to claim 1, wherein
in the generation process, the at least one processor displays the store space on a virtual reality device.

13. An information processing method comprising:
at least one processor generating a virtual store space on a basis of design information related to a store;
the at least one processor acquiring line-of-sight data and feeling data on a user who has entered the store space; and
the at least one processor analyzing the design information on the basis of the line-of-sight data and the feeling data and outputting an analysis result.

14. A non-transitory storage medium storing a program for causing a computer to carry out:
a generation process of generating a virtual store space on a basis of design information related to a store;
an acquisition process of acquiring line-of-sight data and feeling data on a user who has entered the store space; and
an analysis process of analyzing the design information on the basis of the line-of-sight data and the feeling data and outputting an analysis result.
